(19) United States
(12) Patent Application Publication
(10) Pub. No.: US 2019/0392415 A1
(43) Pub. Date: Dec. 26, 2019

(54) FRAMEWORK TO PROMOTE POSITIVE VEHICULAR BEHAVIORS VIA A SOCIAL PAYMENT CONSTRUCT

(71) Applicant: International Business Machines Corporation, Armonk, NY (US)

(72) Inventors: Eric V. Kline, Rochester, MN (US); Sarbajit K. Rakshit, Kolkata (IN)

(21) Appl. No.: 16/015,245

(22) Filed: Jun. 22, 2018

(51) Int. Cl. G06Q 20/26; G06Q 50/00

(52) U.S. Cl. CPC G06Q 20/26; G06Q 50/01

(57) ABSTRACT

Aspects of the invention include detecting, at a first vehicle, a traffic action by a second vehicle. One of a positive action and a rebuke action is selected based on the detected traffic action. Based on the positive action being selected, the selected positive action is transmitted to the second vehicle for communication to the operator of the second vehicle. Based on the rebuke action being selected, the selected rebuke action is transmitted to the second vehicle for communication to the operator of the second vehicle.

### BACKGROUND

Embodiments of the present invention relate in general to promoting positive vehicular behaviors, and more specifically to a framework to promote positive vehicular behaviors via a social payment construct.

Rush hour can be a stressful time for drivers to be on the roadways. In the morning, people are often anxious to get to work on time and at night they are in a rush to get home. This heightened level of driving anxiety, coupled with the increased volume of vehicles on the road, can create high tensions that can lead to road rage. The stress added by rush hour along with other factors such as distracted or fatigued driving can increase driver tension and lead to accidents. Individual drivers can take steps to remain calm and focused while driving, such as listening to calming music, practicing defensive driving techniques, and/or practicing positive vehicular behaviors.

In addition to lowering accident rates, positive vehicular behaviors can also lead to shorter delays caused by traffic. For example, cars executing a “zipper” pattern (e.g., each lane takes a turn when two lanes are merging into a single lane) as a polite approach to a construction zone or other traffic constriction keep the traffic moving in the most expeditious manner. However, if a traffic officer is not present to direct the traffic, drivers left to their own devices can become impolite and cause traffic delays and backups as vehicles force their way back into the traffic stream, often at the last minute. Currently, drivers of vehicles often signal each other using hand gestures or car lights or car horns to thank another driver for letting them into the traffic stream or for other positive/polite behaviors while driving.

Accordingly, while current means for thanking other drivers for their positive driving behavior are suitable for their intended purposes, what is needed is a system or method having certain features of embodiments of the present invention.

### SUMMARY

Embodiments of the present invention include methods, systems, and computer program products for promoting positive vehicular behaviors via a social payment construct. A non-limiting example method includes detecting, at a first vehicle, a traffic action by a second vehicle. Either a positive action or a rebuke action is selected based on the detected traffic action. Based on the positive action being selected, the selected positive action is transmitted to the second vehicle for communicating the selected positive action to an operator of the second vehicle. Based on the rebuke action being selected, the selected rebuke action is transmitted to the second vehicle for communicating the selected rebuke action to the operator of the second vehicle.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a system for promoting positive vehicular behaviors via a social payment construct in accordance with one or more embodiments of the present invention;

FIG. 2 is a flow diagram of a process for promoting positive vehicular behaviors via a social payment construct in accordance with one or more embodiments of the present invention;

FIG. 3 depicts a system for promoting positive vehicular behaviors via a social payment construct in accordance with one or more embodiments of the present invention;

FIG. 4 depicts a cloud computing environment according to one or more embodiments of the present invention;

FIG. 5 depicts abstraction model layers according to one or more embodiments of the present invention; and

FIG. 6 is a block diagram of a computer system for implementing some or all aspects of promoting positive vehicular behaviors via a social payment construct in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

One or more embodiments described herein provide a framework to promote and to encourage driver and pedestrian politeness. One or more embodiments of the present invention include a traffic awareness module that promotes abiding traffic laws and politeness (e.g., turn-taking) by drivers of vehicles by rewarding polite drivers using a non-monetary action (e.g., a thank-you or other action) and/or a monetary action (e.g., a coupon or credit).

In one or more embodiments that include non-monetary actions, the traffic awareness module can be embedded into a vehicle (by the manufacturer or aftermarket) or it can be executing on a mobile device in the vehicle. The traffic awareness module can monitor the user's vehicle situational/traffic awareness including thoroughfare awareness (e.g., construction, accident, slow traffic, etc.). When the traffic situation calls for traffic from two or more lanes to merge down to fewer lanes, the vehicle, via the traffic awareness software, can remind the user to be polite and to allow the alternating traffic zipper to function. If the user fails to allow someone into his lane, then a rebuke can be issued to the driver. If another driver allows the user into their lane, the user's vehicle can broadcast a “thank-you” to the other driver. The rebuke and the thank-you can both be audible (e.g., an audio message) and/or visual (e.g., a visual indicator).

In one or more embodiments that include monetary actions, the traffic awareness module can operate in generally the same manner as the non-monetary action embodiments with a few exceptions. One difference is that the user charges/loads an account associated with the traffic awareness module with money (e.g., $10, $100, etc.). In one or more embodiments, the user is required to keep a minimum balance which can be automatically refreshed using for example, a credit card attached to the account. Upon performing an action that would result in a rebuke (e.g., failing to allow a zipper, slamming on breaks, etc.) the traffic awareness module can debit a payment amount from the user and deposit it into an account of a driver of the impacted vehicle(s). In this manner, bad, rude, or impolite drivers can be motivated to amend their ways.

In one or more embodiments, positive actions and/or rebuke actions can be automatic, or automated, triggered upon some traffic threshold violation or politeness, and/or they can be issued manually by the driver. In one or more embodiments, if a user does not have the specified minimum amount in their account and another user fails to be polite to them, they are not be eligible for a payment since they have not loaded their account; this can provide motivation to keep a balance in their account. In one or more embodiments, the payment amounts are normalized over-all users or by type and/or severity of an offense.

In one or more embodiments, the traffic awareness module is utilized by a pedestrian such that when a person enters a cross-walk (for example), if the driver stops and allows the pedestrian to cross, the pedestrian could via their mobile device ping a credit (e.g., one dollar or a thank-you message) to the driver. Likewise, if the driver fails to stop, the vehicle can credit the pedestrian with a payment or an “I'm sorry message.” Similarly, a pedestrian that J-walks can make a payment or an “I'm sorry” to a driver they disturbed (e.g., via mobile device to car, etc.). In one or more embodiments, both parties are pedestrians communicating thank-you or rebuke actions (e.g., for moving to the right on a crowded escalator, for giving up a seat on a city bus, etc.) via their mobile devices.

As used herein the term “thank-you action” or “positive action” are used interchangeably to refer to a positive reinforcement from driver A to driver B responsive to driver B's polite or courteous driving related action. The reinforcement may be visual, auditory or both. Visual signals may be via conventional automotive equipment (e.g., headlights) or new equipment (e.g., a LED smile on the front grid, etc.). Audio signals may be delivered via Bluetooth (non-directional but proximate) or low power laser (directional), and may be played, or played back, on vehicle B's radio or other media player. The signal may be a default or standard “thank-you” or a custom thank-you from driver A. The thank-you may also include the payment of a token or credit from driver A to B.

As used herein the term “rebuke action” refers to a negative reinforcement that is similar to the thank-you action except it's responsive to an impolite or discourteous action by driver B and may include an LED frown or an audible noise of disapproval. A specific negative driving behavior driver A might want to rebuke is, for example, seeing driver B texting while driving, or driver B tailgating driver A.

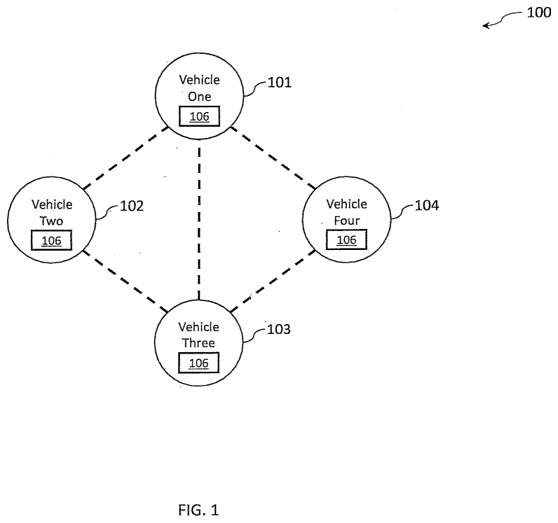

Turning now to FIG. 1, a system 100 for promoting positive vehicular behaviors via a social payment construct is generally shown in accordance with one or more embodiments of the present invention. The system 100 shown in FIG. 1 includes four vehicles: Vehicle One 101, Vehicle Two 102, Vehicle Three 103, and Vehicle Four 104 all containing a traffic awareness module 106. The traffic awareness module 106 can include computer instructions for carrying out the processes described herein as well as a transmitter and receiver (or a transceiver) for a wireless communication method such as, but not limited to Bluetooth or infrared transmission. As shown in FIG. 1, the four vehicles are in communication with each other via a short-range wireless communication method. Four vehicles are shown for ease of description as fewer or more vehicles may be within the range of a vehicle at any given point in time, and which vehicles are within the range of the vehicle can also change over time.

As known in the art, Bluetooth is a short-range wireless technology standard that uses short-wavelength radio waves to transmit and receive data over short distances (e.g., ten meters, one-hundred meters). Bluetooth messages are broadcast from Bluetooth transmitters and can be received by any Bluetooth receivers within a reception range of the Bluetooth transmitters. Thus, as shown in FIG. 1, if Vehicle One 101 broadcasts a thank-you or rebuke message, or action, then traffic awareness modules 106 on all vehicles within the reception range of the Bluetooth message: Vehicle Two 102, Vehicle Three 103, and Vehicle Four 104 will receive the broadcasted message. In one or more embodiments, the thank-you or rebuke message can include additional data indicating which of the vehicles that it is directed to and only the traffic awareness module 106 in the indicated vehicle displays the message.

Another short-range wireless communication method that can be used by one or more embodiments is infrared transmission. As known in the art, infrared transmission is a directed line-of-sight transmission with a transmission range that is typically less than Bluetooth. An infrared transmission message is sent from an infrared transmission transmitter to a selected infrared transmission receiver. In one or more embodiments, the infrared transmission is implemented using a laser. Thus, as shown in FIG. 1, Vehicle One 101 broadcasts a thank-you or rebuke message, or action, to a selected one of Vehicle Two 102, Vehicle Three 103, or Vehicle Four 104. Only the selected vehicle will receive the broadcasted message, via its traffic awareness module 106, from Vehicle One 101. In an embodiment, the traffic awareness module 106 includes a display screen that graphically displays locations of Vehicle Two 102, Vehicle Three 103, and Vehicle Four 104 relative to Vehicle One 101 and the user in Vehicle One 101 can select one of the other vehicles (e.g., via a touch screen, via a voice command) to send the thank-you or rebuke message to. In response to receiving the selection, the traffic awareness module 106 can point the infrared transmission in the direction of the selected vehicle.

In one or more embodiments, the non-monetary thank-you or rebuke action, or message, can include, but is not limited to: a message displayed on a display in the vehicle, a flash of a light or geographic image on the display in the vehicle, and/or a computer recorded voice message. Other visual actions can include, but are not limited to headlights flashing (e.g., three times or in a different color such as green), and lights under the vehicle turning a particular color or pattern of colors. Other audio actions can include, but are not limited to a ring tone or other noise (e.g., hands clapping).

In one or more embodiments, the sending of the thank-you or rebuke action is initiated by a user of the traffic awareness module 106, such as the driver of the vehicle sending the thank-you or rebuke action. The traffic awareness module 106 can include a display screen that graphically displays locations of Vehicle Two 102, Vehicle Three 103, and Vehicle Four 104 relative to Vehicle One 101 and the user in Vehicle One 101 can select one of the other vehicles (e.g., via a touch screen, via a voice command) to send the thank-you or rebuke message to. The locations of the other vehicles can be retrieved for display by car safety software installed in many contemporary automobiles, from navigation software, and/or in other manners.

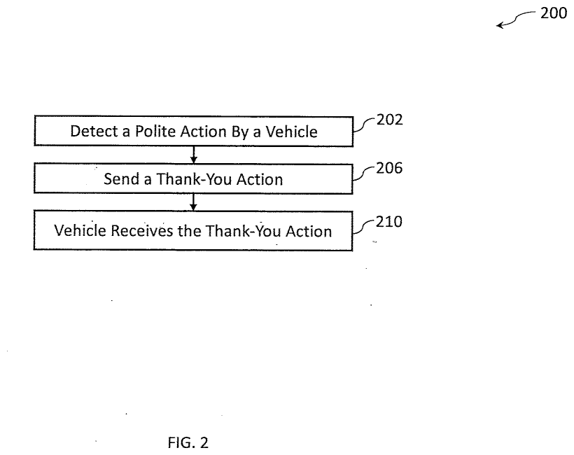

Turning now to FIG. 2, a flow diagram 200 of a process for promoting positive vehicular behaviors via a social payment construct is generally shown in accordance with one or more embodiments of the present invention. The processing shown in FIG. 2 can be performed by a traffic awareness module 106 of FIG. 1. At block 202, a driver of a vehicle detects a polite or rude action by another vehicle. At block 206, the driver of the vehicle sends a thank-you or rebuke action to the other vehicle. At block 210, the other vehicle receives the thank-you or rebuke action. As described previously, the thank-you or rebuke action can be visual or audial. In one or more embodiments, the driver of the vehicle can also send an apology to the other vehicle. In one or more embodiments, when the driver of a vehicle detects an impolite action of another vehicle (e.g., driving below the speed limit in a passing lane, not yielding or zippering, tail gating, etc.), the driver of the vehicle can send a visual or audial rebuke to the other vehicle.

In one or more embodiments, monetary actions are utilized to encourage politeness and situational awareness of vehicle operators. In one or more embodiments, a situation that requires awareness from an operator of a first vehicle is identified. Examples of polite and/or courteous driver B behaviors to be responsively acknowledged can include, but are not limited to: allowing driver A to enter traffic; slowing down and leaving adequate vehicular spacing for speed; not passing in an unsafe manner; not tailgating; and/or pulling over and allowing a safe passing.

In one or more embodiments, the operator is instructed to take a first action with regards to a traffic situation. The instructing can include an audible alert and/or visional alert identifying the first action to take with regards to the situation. Responsive to the operator not taking the first action, an amount of credit can be deducted from an account associated with the operator. The amount of credit can be deposited into an account(s) associated with a vehicle impacted by the operator not taking the first action (e.g., the vehicle that the operator did not take turns with when faced with several lanes merging into fewer lanes). In one or more embodiments, credits are deposited into the account associated with the other vehicle only if the account associated with the other vehicle has a minimum credit value. By enforcing a minimum credit amount in an account before allowing receipt of a credit, embodiments can prevent an operator of a vehicle from only being a recipient of credits and never a giver of credits.

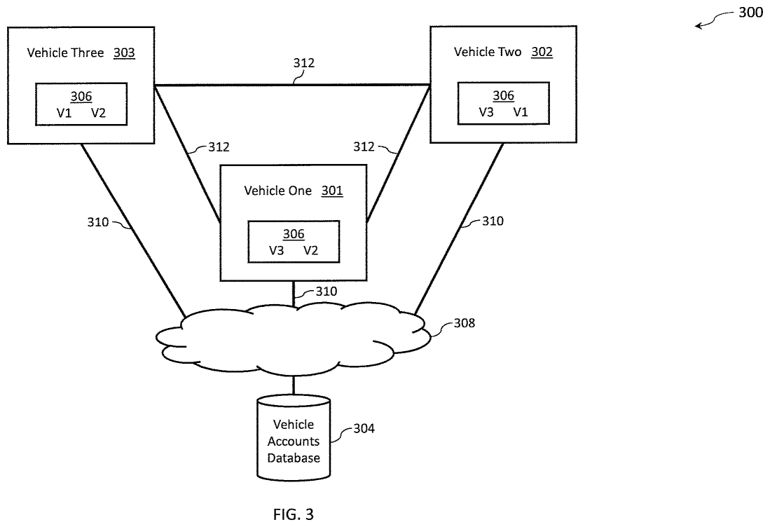

Turning now to FIG. 3, a system 300 for promoting positive vehicular behaviors via a social payment construct is generally shown in accordance with one or more embodiments of the present invention. The system 300 shown in FIG. 3 includes three vehicles: Vehicle One 301, Vehicle Two 302, and Vehicle Three 303 all containing a traffic awareness module 306. Each traffic awareness module 306 can include computer instructions for carrying out the processes described herein as well as a transmitter and receiver, or transceiver, for a directed wireless communication method 312 such as, but not limited to infrared transmission. In addition, each traffic awareness module 306 can include a transceiver for communicating via a wireless communication method 310 with a vehicle accounts database 304 via a network. In one or more embodiments, there is a single transceiver in each traffic awareness module 306 and wireless communication method 312 is the same as wireless communication method 310. In one or more other embodiments, there are multiple transceivers in each of the traffic awareness modules 306, and wireless communication method 312 is different than same wireless communication method 310.

In accordance with one or more embodiments of the present invention, a payment method can include credit of a nominal monetary value from driver A to driver B; and debiting driver A and crediting driver B, where both driver A and driver B have an account set up for this purpose. The transaction can also involve a token of no monetary value, but that is redeemable at participating venues (e.g., restaurants, theaters, gas stations, etc.). The transaction can be executed as a peer-to-peer transaction without a third party. Alternatively, the transaction can be cloud based, involving both drivers' banks, or involving a third party that operates as a transaction agent. For example, drivers A and B can purchase tokens at a fast food restaurant (just as they would buy a $5 gift card) and the fast food restaurant loads their vehicles' accounts (that may reside in the vehicle or in the cloud). Alternatively, drivers A and B can load their accounts from their respective banks, which may load the cars' accounts directly or via the cloud. In order for any vehicle to participate in a monetary exchange, both vehicles would have to have an account with a positive balance, so that they may be debited if need be.

As shown in FIG. 3, the three vehicles are in communication with each other via the short-range wireless communication method 312, and with vehicle accounts database 304 via communication method 310 and network 308. Three vehicles are shown for ease of description as fewer or more vehicles may be within the range of a vehicle at any given point in time, and which vehicles are within the range of the vehicle can also change over time.

The network 308 shown in FIG. 3 can include one or more of any type of known networks including, but not limited to, a wide area network (WAN), a local area network (LAN), a global network (e.g. Internet), a cellular network, a virtual private network (VPN), and an intranet. The network 308 can include a private network in which access thereto is restricted to authorized members. The network 308 can be implemented using wireless networking technologies or any kind of physical network implementation known in the art. The vehicles 301 302 303 and the vehicle accounts database 304 shown in FIG. 3 may be coupled to one or more other components through multiple networks (e.g., Internet, intranet, and private network) so that not all components are coupled to other components through the same network 308.

In one or more embodiments, the vehicle accounts database 304 includes account data for each of the users of the traffic awareness module 106. The account data can be monetary (e.g., dollars) or non-monetary (e.g., tokens or credits to buy a burger at a fast food restaurant or to get a free gallon of milk, etc.). For example, it can take ten tokens to earn a free gallon of milk, or ten credits for to get five dollars off a meal at a restaurant. The account balance can be stored in the vehicle and/or in the cloud (e.g., in a storage device accessed via a network). Accounts can be associated with the vehicle or with the driver. For example, a family may have two cars, and if the husband and wife always drive their own cars, the accounts can be associated with the vehicles. In another example, a family may have two cars that are regularly driven by different drivers (e.g., a husband and wife switch cars) and in this case, the accounts can be associated with the drivers.

The account data can be stored in any known type of memory or storage device and in any known format and is not limited to being stored in the vehicle accounts database 304 shown in FIG. 3.

In one or more embodiments, a monetary thank-you action can include, but is not limited to: depositing a monetary amount (e.g., $2, $5, $10) in a user's account, and depositing a coupon for a discounted or free item in the user's account. In one or more embodiments, a rebuke action can include, but is not limited to: removing a monetary amount (e.g., $2, $5, $10) from the user's account, and removing or degrading a coupon for a discounted or free item in the user's account. In an embodiment, when money is deposited in the account of one user (e.g., the person being thanked for being polite or the person having been the object of rude behavior), it is debited from the account of another user (e.g., the person doing the thanking or the person being rebuked). One or more embodiments of the traffic awareness module 306 can verify that both users have accounts and that both have credit balances above a specified minimum amount. The specified minimum can be a system wide minimum amount and/or the amount may vary based on the observed action.

In one or more embodiments, a credit amount can be split between two or more accounts. In one or more embodiments, different amounts are credited or debited for different observed actions. In one or more embodiments, a monetary thank-you or rebuke action can be in addition to the non-monetary thank-you or rebuke actions described previously. Similarly, both monetary and non-monetary rebukes can be performed in response to the same observed rude behavior.

In one or more embodiments, the sending of the monetary thank-you or rebuke action is initiated by a user of the traffic awareness module 306, such as the driver of the vehicle sending the thank-you or rebuke action. The traffic awareness module 306 on Vehicle One 301 can include a display screen that graphically displays locations of Vehicle Two 302 and Vehicle Three 303 relative to Vehicle One 301. The traffic awareness module 306 on Vehicle Two 302 can include a display screen that graphically displays locations of Vehicle One 301 and Vehicle Three 303 relative to Vehicle Two 302. The traffic awareness module 306 on Vehicle Three 303 can include a display screen that graphically displays locations of Vehicle One 301 and Vehicle Two 302 relative to Vehicle Three 303. The operator of Vehicle One 301 for example, can select one of the other vehicles (e.g., via a touch screen, via a voice command) to send the thank-you or rebuke message to.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

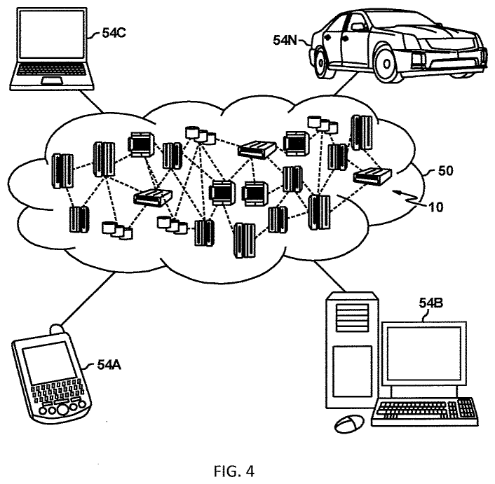

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

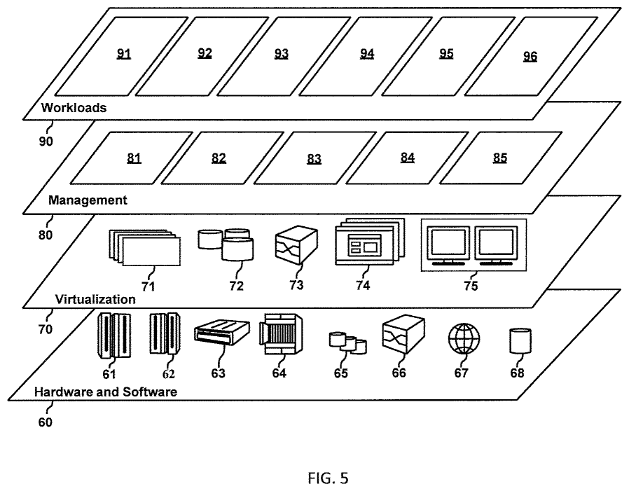

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

In accordance with one or more embodiments of the present invention, systems shown in FIGS. 1-3 are located in the cloud computing environment of FIG. 5 where all or a subset of the processing described herein is performed.

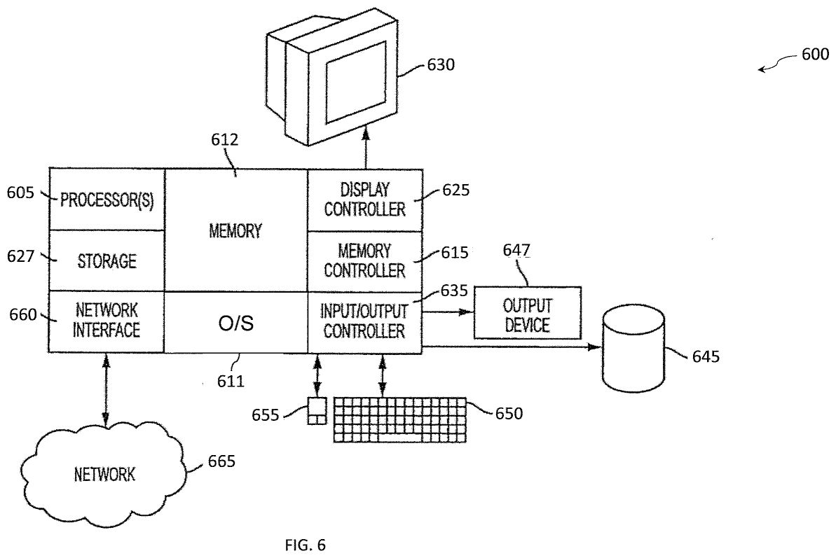

Turning now to FIG. 6, a block diagram of a computer system 600 for implementing some or all aspects of promoting positive vehicular behaviors via a social payment construct is generally shown in accordance with one or more embodiments of the present invention. The processing described herein may be implemented in hardware, software (e.g., firmware), or a combination thereof. In an exemplary embodiment, the methods described may be implemented, at least in part, in hardware and may be part of the microprocessor of a special or general-purpose computer system 600, such as a mobile device, personal computer, workstation, minicomputer, or mainframe computer.

In an exemplary embodiment, as shown in FIG. 6, the computer system 600 includes a processor 605, memory 612 coupled to a memory controller 615, and one or more input devices 645 and/or output devices 647, such as peripherals, that are communicatively coupled via a local I/O controller 635. These devices 647 and 645 may include, for example, a printer, a scanner, a microphone, and the like. A conventional keyboard 650 and mouse 655 may be coupled to the I/O controller 635. The I/O controller 635 may be, for example, one or more buses or other wired or wireless connections, as are known in the art. The I/O controller 635 may have additional elements, which are omitted for simplicity, such as controllers, buffers (caches), drivers, repeaters, and receivers, to enable communications.

The I/O devices 647, 645 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 605 is a hardware device for executing hardware instructions or software, particularly those stored in memory 612. The processor 605 may be a custom made or commercially available processor, a central processing unit (CPU), an auxiliary processor among several processors associated with the computer system 600, a semiconductor based microprocessor (in the form of a microchip or chip set), a microprocessor, or other device for executing instructions. The processor 605 can include a cache such as, but not limited to, an instruction cache to speed up executable instruction fetch, a data cache to speed up data fetch and store, and a translation look-aside buffer (TLB) used to speed up virtual-to-physical address translation for both executable instructions and data. The cache may be organized as a hierarchy of more cache levels (L1, L2, etc.).

The memory 612 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 612 may incorporate electronic, magnetic, optical, or other types of storage media. Note that the memory 612 may have a distributed architecture, where various components are situated remote from one another but may be accessed by the processor 605.

The instructions in memory 612 may include one or more separate programs, each of which comprises an ordered listing of executable instructions for implementing logical functions. In the example of FIG. 6, the instructions in the memory 612 include a suitable operating system (OS) 611. The operating system 611 essentially may control the execution of other computer programs and provides scheduling, input-output control, file and data management, memory management, and communication control and related services.

Additional data, including, for example, instructions for the processor 605 or other retrievable information, may be stored in storage 627, which may be a storage device such as a hard disk drive or solid state drive. The stored instructions in memory 612 or in storage 627 may include those enabling the processor to execute one or more aspects of the dispatch systems and methods of this disclosure.

The computer system 600 may further include a display controller 625 coupled to a display 630. In an exemplary embodiment, the computer system 600 may further include a network interface 660 for coupling to a network 665. The network 665 may be an IP-based network for communication between the computer system 600 and an external server, client and the like via a broadband connection. The network 665 transmits and receives data between the computer system 600 and external systems. In an exemplary embodiment, the network 665 may be a managed IP network administered by a service provider. The network 665 may be implemented in a wireless fashion, e.g., using wireless protocols and technologies, such as WiFi, WiMax, etc. The network 665 may also be a packet-switched network such as a local area network, wide area network, metropolitan area network, the Internet, or other similar type of network environment. The network 665 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods for providing a framework to promote positive vehicular behaviors via a social payment construct can be embodied, in whole or in part, in computer program products or in computer systems 600, such as that illustrated in FIG. 6.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
detecting, at a first vehicle, a traffic action by a second vehicle;
selecting one from the group consisting of a positive action and a rebuke action, the selecting based on the detected traffic action;
based on the positive action being selected, transmitting the selected positive action to the second vehicle for communication to an operator of the second vehicle; and
based on the rebuke action being selected, transmitting the selected rebuke action to the second vehicle for communication to the operator of the second vehicle.

2. The method of claim 1, wherein the detecting is by an operator of the first vehicle.

3. The method of claim 1, wherein the detecting is automated based on safety software executing in the first vehicle.

4. The method of claim 3, wherein the automated detecting is further based on navigation software executing in the first vehicle.

5. The method of claim 1, wherein one or both of the positive action and the rebuke action include a visual indicator.

6. The method of claim 1, wherein one or both of the positive action and the rebuke action include an audio message.

7. The method of claim 1, wherein the positive action includes a credit to an account of the operator of the second vehicle and a debit to an account of an operator the first vehicle.

8. The method of claim 1, wherein the rebuke action includes a credit to an account of an operator of the first vehicle and a debit to an account of the operator the second vehicle.

9. The method of claim 1, wherein the positive action is an apology from an operator of the first vehicle to the operator of the second vehicle.

10. A system comprising:
a memory having computer readable instructions; and
one or more processors for executing the computer readable instructions, the computer readable instructions controlling the one or more processors to perform operations comprising:
detecting, at a first vehicle, a traffic action by a second vehicle;
selecting one from the group consisting of a positive action and a rebuke action, the selecting based on the detected traffic action;
based on the positive action being selected, transmitting the selected positive action to the second vehicle for communication to an operator of the second vehicle; and
based on the rebuke action being selected, transmitting the selected rebuke action to the second vehicle for communication to the operator of the second vehicle.

11. The system of claim 10, wherein the detecting is by an operator of the first vehicle.

12. The system of claim 10, wherein the detecting is automated based on safety software executing in the first vehicle.

13. The system of claim 10, wherein one or both of the positive action and the rebuke action include a visual indicator.

14. The system of claim 10, wherein the positive action and the rebuke action include an audio message.

15. The system of claim 10, wherein the positive action includes a credit to an account of the operator of the second vehicle and a debit to an account of an operator the first vehicle.

16. The system of claim 10, wherein the rebuke action includes a credit to an account of an operator of the first vehicle and a debit to an account of the operator the second vehicle.

17. The system of claim 10, wherein the positive action is an apology from an operator of the first vehicle to the operator of the second vehicle.

18. A computer program product comprising a computer readable storage medium having program instructions embodied therewith, the program instructions executable by a processor to cause the processor to perform operations comprising:
detecting, at a first vehicle, a traffic action by a second vehicle;
selecting one from the group consisting of a positive action and a rebuke action, the selecting based on the detected traffic action;
based on the positive action being selected, transmitting the selected positive action to the second vehicle for communication to an operator of the second vehicle; and
based on the rebuke action being selected, transmitting the selected rebuke action to the second vehicle for communication to the operator of the second vehicle.

19. The computer program product of claim 18, wherein the positive action includes a credit to an account of the operator of the second vehicle and a debit to an account of an operator the first vehicle.

20. The computer program product of claim 18, wherein the rebuke action includes a credit to an account of an operator of the first vehicle and a debit to an account of the operator the second vehicle.
